(19) United States
(12) Patent Application Publication
(10) Pub. No.: US 2026/0163894 A1
(43) Pub. Date: Jun. 11, 2026

(54) METHOD AND SYSTEM FOR PRIORITIZING CYBER-SECURITY EVENTS

(71) Applicant: CLOUDSEK RESEARCH PTE. LTD., Singapore (SG)

(72) Inventors: Rahul Sasi, Bengaluru (IN); Syed Shahrukh Ahmad, Bengaluru (IN); Nithya Kurian, Kottayam (IN)

(21) Appl. No.: 19/181,229

(22) Filed: Apr. 16, 2025

(30) Foreign Application Priority Data
Apr. 17, 2024 (IN) 202441030871

(51) Int. Cl. H04L 9/40

(52) U.S. Cl. CPC H04L 63/1416; H04L 63/1433

(57) ABSTRACT

Embodiments herein provide a system and a method for prioritizing different levels of threats in an organization using one or more dynamic rules. The method includes identifying one or more cyber-event parameters as identifier tags for one or more cyber-security events in a computing environment of an organization, wherein the one or more identifier tags facilitate in identifying a risk factor associated with each cyber-security event of the one or more cyber-security events. The method also involves creating one or more dynamic rules in response to analysis of the one or more cyber-event parameters and the one or more identifier tags of each cyber-security event. Further, the method includes applying, in real-time, the one or more dynamic rules to the one or more cyber-security events to assign a priority to each cyber-security event of the one or more cyber-security events.

### CROSS-REFERENCE TO RELATED APPLICATIONS

This application claims priority to Indian Patent Application No. 202441030871, filed on Apr. 17, 2024, the disclosure and contents of which are incorporated by reference in their entireties.

### TECHNICAL FIELD

The present disclosure relates to cyber threats in a dynamic cyber-security environment and more particularly to a method for prioritizing cyber security events.

### BACKGROUND

The following description of related art is intended to provide background information pertaining to the field of the present disclosure. This section may include certain aspects of the art that may be related to various aspects of the present disclosure. However, it should be appreciated that this section be used only to enhance the understanding of the reader with respect to the present disclosure, and therefore, unless otherwise indicated, it should not be assumed that any of the approaches described in this section qualify as prior art merely by virtue of their inclusion in this section.

Rapid advancement of technology and digital systems has led to an increase in cyber security threats, making cyber security a critical concern for individuals as well as organizations. The ability to analyze, understand and respond to security threats is essential for ensuring protection of sensitive data.

Generally, artificial intelligence (AI)/machine learning (ML) mechanisms are used to tackle cyber security threats. The conventional AI/ML mechanisms predict if a cyber-security event is a threat for an organization or not. Further, when the threat is detected, the conventional AI/ML mechanisms segregate the threat into different security levels, for example, high, medium or low. These security levels are assigned to ascertain which threats the processing system should remediate first. However, keeping training datasets stored in a storage completely up to date with the daily and dynamic changes in the cyber-security market as well as the unique characteristics and situations faced by the organization is a significant challenge. Hence, due to the limited dataset maintenance, the prediction by the AI/ML mechanisms are inaccurate. In addition, it is challenging to train the AI/ML mechanism or models to ensure 100% accuracy, hence, the AI/ML mechanism occasionally predict false positive threats. Furthermore, given a large number of threats stored in the storage, a simple categorization of high/medium/low is not enough to help the organization understand top critical incidents, which could have a severe impact.

### SUMMARY

The principal objective of the invention is to provide a method and system for prioritizing one or more cyber-security events.

It is an object of the present disclosure to mitigate, alleviate or eliminate one or more of the above-identified deficiencies and disadvantages in the prior art and solve at least the above-mentioned problem.

According to a first aspect, there is provided a method for prioritizing one or more cyber-security events. The method comprises identifying one or more cyber-event parameters as identifier tags for one or more cyber-security events in a computing environment of an organization, wherein the one or more identifier tags facilitate in identifying a risk factor associated with each cyber-security event of the one or more cyber-security events. Further, the method comprises creating one or more dynamic rules in response to analysis of the one or more cyber-event parameters and the one or more identifier tags of each cyber-security event. In addition, the method comprises applying, in real-time, the one or more dynamic rules to the one or more cyber-security events to assign a priority to each cyber-security event of the one or more cyber-security events. The method comprises prioritizing the one or more cyber-security events as per the assigned priority of each cyber-security event.

In some embodiments, the one or more cyber-event parameters comprise one or more attributes of the one or more cyber-security events collected from different sources. The one or more attributes comprise at least one of a type of the corresponding cyber-security event, a source of the corresponding cyber-security event, a targeted asset, a severity score and a time of occurrence of the corresponding cyber-security event. Further, the one or more identifier tags comprise at least one of a threat indicator tag, an asset tag, a Common Vulnerabilities and Exposures (CVE) tag, a module tag, and a threat actor tag, in which each identifier tag is assigned with a weightage that corresponds to contribution of the corresponding identifier tag in identifying the risk factor.

In some embodiments, the risk factor facilities to determine a business impact and a financial impact associated with the business impact, and an asset criticality.

In some embodiments, the one or more dynamic rules arranges the one or more cyber-security events according to one or more threat levels associated with each cyber-security event.

In some embodiments, the method comprises applying one or more dynamic correlation rules to correlate two or more cyber-security events based on shared parameters, wherein the shared parameters comprise common assets associated with the two or more cyber-security events, vulnerability exposure of two or more cyber-security events, exploit paths, or attacker behaviour patterns found in stealer logs or malware. The method further comprises assigning the priority to rank the two or more correlated events based on risk factors comprising at least one of an exploitability, asset criticality, business impact, and likelihood of attack.

In some embodiments, the priority is assigned according to a probability of cyber loss associated with each cyber-security event from the one or more cyber-security events and the risk factor associated with each cyber-security event. In addition, the probability is determined according to one or more characteristics of the organization comprising revenue, industry, location, and employee headcount.

In some embodiments, the one or more cyber-event parameters comprises business parameters further comprising one or more of: data breach, ransomware, and/or financial fraud. In addition, the one or more cyber-event parameters comprises social media and dark web discussions for a technology resulting in a cyber-security threat associated with the one or more cyber-security events. In addition, the one or more cyber-event parameters comprise compliance status comprising data representing a probability of compliance of applicable regulatory requirements. Further, the one or more cyber-event parameters comprises patterns of cyber-security threat events determined from global threat event data mapping with the one or more cyber-security events.

In some embodiments, the analyzing the one or more cyber-event parameters and the one or more identifier tags comprises identifying one of an increment or decrement in the social media and dark web discussions for the technology resulting in the cyber-security threat event.

In some embodiments, the one or more dynamic rules comprise a boosting rule or a diminishing rule, applied in response to an update in the analysis of one or more cyber-event parameters and weightage assigned to each identifier tag. Further, the update comprises one of an increment or decrement in the social media and dark web discussions for the technology resulting in the cyber-security threat event.

In some embodiments, the boosting rule is applied to boost the priority order of the cyber-security event for the increment in the social media and dark web discussions. In addition, the diminishing rule is applied for the decrement in the social media and dark web discussions.

According to a second aspect, there is provided a system for prioritizing one or more cyber-security events. The system comprises a memory configured to store instructions. The system also comprises a processor. The processor is configured to execute the instructions stored in the memory. The processor is configured to identify one or more cyber-event parameters as identifier tags for one or more cyber-security events in a computing environment of an organization, wherein the one or more identifier tags facilitate in identifying a risk factor associated with each cyber-security event. The processor is further configured to create one or more dynamic rules in response to analysis of the one or more cyber-event parameters and the one or more identifier tags of each cyber-security event. In addition, the processor is configured to apply, in real-time, the one or more dynamic rules to the one or more cyber-security events to assign a priority to each cyber-security event of the one or more cyber-security events. Furthermore, the processor is configured to prioritize the one or more cyber-security events as per the assigned priority of each cyber-security event.

According to a third aspect, there is provided a computer program product comprising instructions stored therein, which when executed, causes the processor of the system to perform corresponding steps of method for prioritizing one or more cyber-security events.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF ACCOMPANYING DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIG. 1 illustrates a network implementation of a system for prioritizing cyber-security events, according to some embodiments of the invention;

FIG. 2 illustrates a block diagram of the system for prioritizing cyber-security events, according to some embodiments of the invention;

FIG. 3 illustrates a flowchart illustrating example method steps of a method performed by the system for prioritizing cyber-security events, according to some embodiments of the invention;

FIG. 4 illustrates additional details of the method for estimating risk in an organization due to the cyber threats, according to some embodiments of the invention; and

FIG. 5 discloses an example computing environment, according to some embodiments of the invention.

### DETAILED DESCRIPTION OF THE PREFERRED EMBODIMENT

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

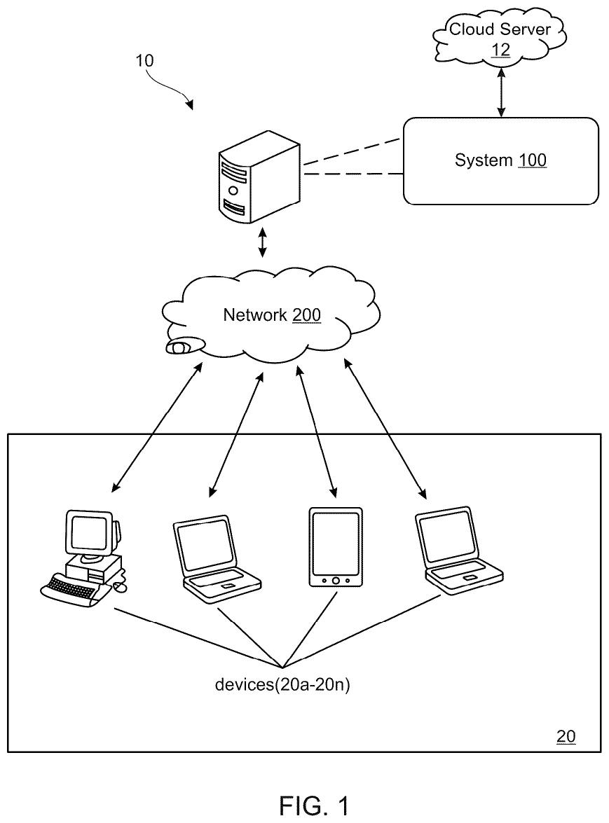

FIG. 1 discloses a network implementation 10 of a system 100 arranged to communicate with a cloud server 12 and a plurality of devices 20a-20n (collectively referred as system 20). The plurality of devices 20a-20n are configured to communicate with each other via a network 200. The network implementation 10 further includes a server (not shown) that is connected to the system 100. The server may be further connected to the plurality of devices 20a-20n through the network 200. The system 100 is used for prioritizing one or more cyber-security events in a computing environment of an organization. In some embodiments of the present disclosure, the system 100 may be configured for adapting a prioritization of cyber-security events based on organizational behavior and external threat signals.

It may be understood that the server, the system 100, and the plurality of communication devices (20a-20n) correspond to computing devices. It may be understood that the server (local server/remote/server/cloud server) may also be implemented in a variety of computing systems such as, a laptop computer, a desktop computer, a notebook, a workstation, a mainframe computer, a network server, a cloud-based computing environment, or a smart phone, and the like. It may be understood that the system 100 may correspond to a variety of portable devices. Further, it may be understood that the system 100 may be, but not limited to, power saving device.

In an example implementation, the network 200 may be a wireless network, a wired network, or a combination thereof. The network 200 can be implemented as one of the different types of networks, such as intranet, Local Area Network, LAN, Wireless Personal Area Network, WPAN, Wireless Local Area Network, WLAN, wide area network, WAN, the Internet, and the like. The network 200 may either be a dedicated network or a shared network. The shared network represents an association of the different types of networks that use a variety of protocols, for example, MQ Telemetry Transport, MQTT, Extensible Messaging and Presence Protocol, XMPP, Hypertext Transfer Protocol, HTTP, Transmission Control Protocol/Internet Protocol, TCP/IP, Wireless Application Protocol, WAP, and the like, to communicate with one another. Further, the communication network 200 may include a variety of network devices, including routers, bridges, servers, computing devices, storage devices, and the like.

In accordance with the embodiments disclosed herein, the server is configured for establishing the communication between the system 100 and the plurality of communication devices 20a-20n. For example, the server is configured to receive security threat data from a plurality of sources through the device 20a-20n.

Further, the cloud server 12 is configured to receive various parameters from the system 100 and process the various parameters regarding the plurality of devices 20a-20n configured in the system 20 using the machine learning model and AI algorithms.

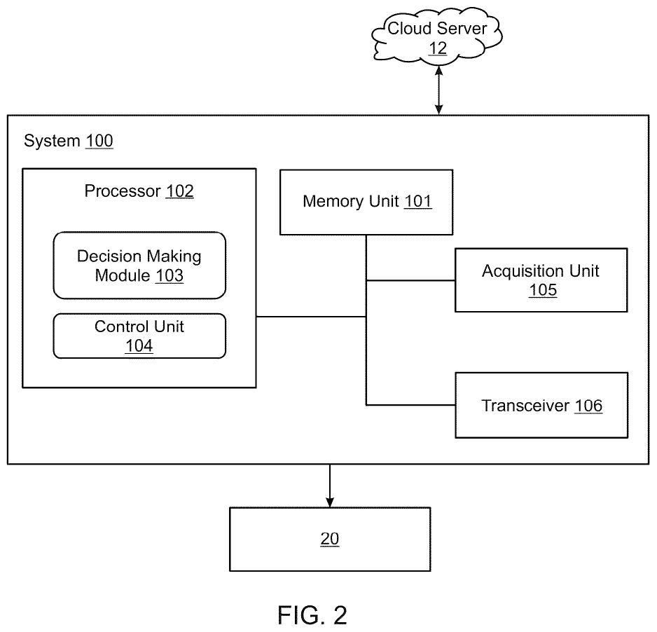

FIG. 2 is an example block diagram of the system 100. As depicted in FIG. 2, the system 100 comprises a memory 101 and a processor 102. The processor 102 may comprise a decision-making module 103, and a control unit 104. Further the processor 102 may be integrated to each of an acquisition unit 105 and a transceiver 106. In an example, the acquisition unit 105 is configured to collect various data on one or more technologies being used by an organization and information about peer organizations working in the same field. Further, the transceiver 106 is configured to communicate the information collected by the acquisition unit 105 to the decision-making module 103 and cloud server 12. The control unit 104 is further configured to create and apply one or more dynamic rules stored in the memory 101, on the system 100 (shown in FIG. 2) based on an output of the decision-making module 102.

In some embodiments, the system 100 for prioritizing one or more cyber-security events comprises the memory 101 configured to store instructions. Further, the processor 102 is configured to execute the instructions stored in the memory 101. The processor 102 is configured to identify one or more cyber-event parameters as identifier tags for one or more cyber-security events in a computing environment of an organization, wherein the one or more identifier tags facilitate in identifying a risk factor associated with each cyber-security event of the one or more cyber-security events. The processor 102 is further configured to create one or more dynamic rules in response to analysis of the one or more cyber-event parameters and the one or more identifier tags of each cyber-security event. In addition, the processor 102 is configured to apply, in real-time, the one or more dynamic rules to the one or more cyber-security events to assign a priority to each cyber-security event of the one or more cyber-security events. Furthermore, the processor 102 is configured to prioritize the one or more cyber-security events as per the assigned priority of each cyber-security event.

In an example, the processor 102 is configured to prioritize at least one cyber-security event based on the assigned priority to remediate the corresponding prioritized cyber security event.

In an example, the one or more cyber-event parameters comprise one or more attributes of the one or more cyber-security events collected from different sources, wherein the one or more attributes comprise at least one of a type of the corresponding cyber-security event, a source of the corresponding cyber-security event, a targeted asset, a severity score and a time of occurrence of the corresponding cyber-security event. Further, the one or more identifier tags comprise at least one of a threat indicator tag, an asset tag, a common vulnerabilities and exposures (CVE) tag, a module tag, and a threat actor tag, wherein each identifier tag assigned with a weightage that corresponds to contribution of the corresponding identifier tag in identifying the risk factor.

Embodiments of the present disclosure are intended to include and/or otherwise cover any type of identifier tags that facilitate in identifying the risk factor associated with each cyber-security event of the one or more cyber-security events, without deviating from the scope of the present disclosure.

In an example, the risk factor facilitates to determine a business impact, and a financial impact associated with the business impact, and an asset criticality.

Further, in an example, the one or more dynamic rules arranges the one or more cyber-security events according to one or more threat levels associated with each cyber-security event.

In an example, the processor 102 is configured to apply one or more dynamic correlation rules to correlate one or more cyber-security events based on shared parameters, wherein the shared parameters comprise common assets associated with the two or more cyber-security events, vulnerability exposure of two or more cyber-security events, exploit paths, misconfigurations, or attacker behaviour patterns found in stealer logs or malware. The processor 102 is further configured to assign the priority to rank the two or more correlated events based on risk factors comprising at least one of an exploitability, asset criticality, business impact, and likelihood of attack.

In an example, the priority is assigned according to a probability of cyber loss associated with each cyber-security event from the one or more cyber-security events and the risk factor associated with each cyber-security event. Further, the probability is determined according to one or more characteristics of the organization comprising revenue, industry, location, and employee headcount.

In another example, prioritizing the one or more cyber-security events as per the assigned priority of each cyber-security event yields a financial risk value associated with each cyber-security event that enables a user of system 100 to make informed decisions about which cyber-security event to remediate first. In an exemplary scenario, if the financial risk value of the at least one cyber-security event is high, a high priority is assigned in the prioritization of the corresponding at least one cyber event. Further, if the financial risk value of the at least one cyber-security event is low, a low priority is assigned in the prioritization of the corresponding at least one cyber event.

In an example, the one or more cyber-event parameters comprises business parameters further comprising one or more of: data breach, ransomware, or financial fraud. In addition, the one or more cyber-event parameters comprises social media and dark web discussions for a technology resulting in a cyber-security threat associated with the one or more cyber-security events and patterns of cyber-security threat events determined from global threat event data mapping with the one or more cyber-security events. In addition, the one or more cyber-event parameters comprise compliance status comprising data representing a probability of compliance of applicable regulatory requirements. In an example, the regulatory requirements may include General Data Protection Regulation (GDPR) requirements.

In another example, to analyze the one or more cyber-event parameters and the one or more identifier tags, the processor 102 is configured to identify one of an increment or decrement in the social media and dark web discussions for the technology resulting in the cyber-security threat event.

In an example, the one or more dynamic rules comprise a boosting rule or a diminishing rule, applied in response to an update in the analysis of one or more cyber-event parameters and weightage assigned to each identifier tag. Further, the update comprises one of an increment or decrement in the social media and dark web discussions for the technology resulting in the cyber-security threat event. In an exemplary embodiment, if there's a surge in social media or dark web discussions about a technology tied to a cyber-security threat, the system 100 boosts the priority for the corresponding cyber-security event. Further, if the chatter regarding the social media or dark web discussions about a technology tied to a cyber-security threat dies down, the system 100 will diminish the priority of the corresponding cyber-security threat.

In an example, the boosting rule is applied to boost the priority of the cyber-security event for the increment in the social media and dark web discussions. Furthermore, the diminishing rule is applied for the decrement in the social media and dark web discussions.

In an example, the processor 102 is configured to simulate one or more potential attack paths by way of an agent-based modeling technique, wherein the agent-based modeling technique employs one or more autonomous agents in the computing environment to mimic the attacker behaviour patterns by identifying exploitable vulnerabilities, correlating one or more cyber-security events, and constructing potential attack chains. Further, the processor 102 is configured to reprioritize the correlated cyber-security events based on simulated one or more potential attack paths. In addition, the one or more autonomous agents leverage breach patterns utilized in past cyber-security events and real-time telemetry to update their internal logic and simulate new attack vectors dynamically.

In an example, the processor 102 comprises an agent-based simulation engine configured to enable the one or more autonomous agents to mimic the attacker behaviour patterns. The autonomous agents are configured to map, analyze, and simulate potential attack paths by interacting with assets which are publicly exposed. Further, the one or more autonomous agents are configured to discover externally reachable elements of the computing environment such as domains, IP addresses, ports, and services. The one or more autonomous agents are configured to identify weak signals of exposure, including open ports, outdated software versions, misconfigured services, and accessible metadata. In addition, the one or more autonomous agents are configured to infer vulnerabilities based on observed technologies, security headers, or known version fingerprints. The one or more autonomous agents are also configured to simulate attack chains by linking multiple observations that may be combined by a real-world attacker (For example, an exposed admin panel with weak authentication leading to an outdated content management system (CMS) with a known attack path).

Furthermore, the one or more autonomous agents simulate a logical progression of an attack from initial access to lateral movement across exposed services, based on known tactics and publicly available intelligence. The result is a ranked set of two or more correlated cyber-security events with associated attack paths.

In another example, the simulated attack paths are used to prioritize vulnerabilities that may seem low-risk in isolation but are part of a high-impact chain. Further, the simulated attack paths are used to apply a dynamic scoring adjustments based on discoverability and exploitability of chained exposures. In addition, the simulated attack paths are used to enhance the context and explainability of the prioritization engine through identified attack paths. The one or more autonomous agents, while performing simulation, are configured to function without requiring internal access to computing environment 10, relying entirely on external enumeration and analysis. This ensures applicability in scenarios where internal telemetry or agent deployment is not possible.

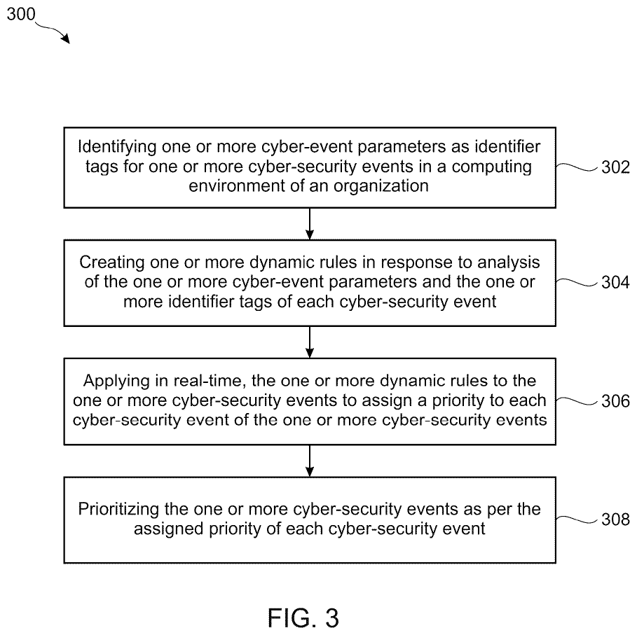

FIG. 3 represents a flowchart illustrating example steps of a method 300 for prioritizing one or more cyber-security events. The method 300 may be executed through the system 100.

The order in which the steps of the method 300 is described is not intended to be construed as a limitation, and any number of the described method steps may be combined in any order to implement the method 300 or alternate methods. Additionally, individual steps may be deleted from the method 300 without departing from the scope of the invention as defined in the claims.

At step 302, the method 300 comprises identifying the one or more cyber-event parameters as identifier tags for the one or more cyber-security events in a computing environment of an organization. The one or more identifier tags facilitate in identifying the risk factor associated with each cyber-security event of the one or more cyber-security event.

At step 304, the method 300 comprises creating one or more dynamic rules in response to analysis of the one or more cyber-event parameters and the one or more identifier tags of each cyber-security event.

At step 306, the method 300 comprises applying in real-time, the one or more dynamic rules to the one or more cyber-security events to assign the priority to each cyber-security event of the one or more cyber-security events.

At step 308, the method 300 comprises prioritizing the one or more cyber-security events as per the assigned priority of each cyber-security event.

In an example, the method 300 comprises prioritizing at least one cyber-security event based on the assigned priority for remediating the corresponding prioritized cyber security event.

In another example, the remediating of the one or more cyber-security event comprises one or more of: correcting, mitigating, and/or resolving the one or more cyber-security event.

In some embodiments, the one or more cyber-event parameters comprise one or more attributes of the one or more cyber-security events collected from different sources. The one or more attributes comprise at least one of a type of the corresponding cyber-security event, a source of the corresponding cyber-security event, a targeted asset, a severity score and a time of occurrence of the corresponding cyber-security event. Further, the one or more identifier tags comprise at least one of a threat indicator tag, an asset tag, a common vulnerabilities and exposures (CVE) tag, a module tag, and a threat actor tag. In addition, each identifier tag is assigned with a weightage that corresponds to contribution of the corresponding identifier tag in identifying the risk factor.

In an example, while identifying one or more cyber-event parameters, there are one or more attributes or characteristics collected from different sources that describe various aspects of the one or more cyber-security event. For example, the type of cyber-security event comprises one or more of: phishing, malware, credential leak; the source of the cyber-security event comprises one or more of: dark web, web app, external attack surface; the targeted asset comprises one or more of: IP address, domain, cloud server; the severity score comprises one or more of: a CVSS score, an internal risk score, threat tags found on the event; and the time of occurrence of the cyber-security event comprises a timestamp of the event.

Further, in an example, the identifier tags comprise unique labels or metadata assigned to one or more cyber-security events to help identify the one or more cyber-security event's specifics and enable correlation across various data sources. In addition, the identifier tags may be used to categorize and link multiple events. For example, the threat indicator tags categorize application programming interface (API) keys and internal subdomains found. In addition, the asset tag is label indicating the specific system or asset affected (e.g., server ID, domain name). The CVE tag indicates the CVE associated with the event. Further, the module tag refers to the application or system module affected (e.g., API endpoint, cloud infrastructure). In addition, the threat actor tag identifies the potential threat actor or group responsible (e.g., based on TTPs or past events). In an exemplary scenario, for a vulnerability exploit on a web app, tags may include a CVE tag for the vulnerability, and an asset tag identifying the specific web server impacted.

In another example, the risk factor facilitates to determine a business impact, and a financial impact associated with the business impact, and an asset criticality.

In an example, the risk factor identified comprises the parameters and tags that help in identifying and quantifying the potential risk associated with each cyber-security event. The risk factors include business impact and its financial impact comprising exposure of sensitive data, disruption of services, and potential financial losses. The risk factors further include a criticality of asset comprising whether the asset is a high-value target like a critical server or a non-critical endpoint.

In some embodiments, the one or more dynamic rules arranges the one or more cyber-security events according to one or more threat levels associated with each cyber-security event. In an example, threat levels are identified based on a combination of risk factors associated with each one or more cyber-security event. These factors include the exploitability of the CVE, the criticality of the affected asset, and the potential business impact of the event. The system 100 and the method 300 uses this information to determine the severity or threat level of each one or more cyber-security event, assigning a priority to guide response actions.

In an exemplary scenario, a vulnerability (CVE) is detected in a cloud server 12. The threat level would be determined based on exploitability i.e., how easy it is for an attacker to exploit the vulnerability (e.g., whether it requires authentication or specific conditions), asset criticality i.e., the importance of the asset (e.g., a public-facing server handling sensitive customer data vs. an internal system), and business impact i.e., the financial or reputational damage that could result from exploitation (e.g., data exposure, service downtime, regulatory fines). If this vulnerability affects a critical public-facing server and is easily exploitable, the system 100 will assign it a high threat level due to the high risk factor, while less critical vulnerabilities with lower exploitability would be assigned lower threat levels. Therefore, by combining these factors, the one or more dynamic correlation rules arrange the two or more cyber-security events based on their respective threat levels, ensuring that high-risk cyber-security events are prioritized for investigation and mitigation.

In some embodiments, the method 300 comprises applying one or more dynamic correlation rules to correlate two or more cyber-security events based on shared parameters. The shared parameters comprise common assets associated with the two or more cyber-security events, vulnerability exposure of two or more cyber-security events, exploit paths, or attacker behaviour patterns found in stealer logs or malware. The method 300 further comprises assigning the priority to rank the two or more correlated events based on the risk factors comprising at least one of an exploitability, asset criticality, business impact, and likelihood of attack.

In an embodiment, event correlation or correlating two or more cyber-security events is the process of analyzing and linking multiple cyber-security events to identify potential connections, patterns, and overarching threats. Event correlation involves aggregating disparate data points, such as vulnerabilities (e.g., CVEs), misconfigurations, and attacker behaviours, into a cohesive narrative that highlights exploit paths, enabling organizations to prioritize and address high-risk threats. Further, by applying dynamic correlation rules, the method 300 or system 100 identifies shared parameters across two or more cyber-security events, such as common assets, exploit paths, or behavioural indicators. Further, in an example, exposed credentials found in stealer logs might correlate with misconfigured cloud servers, creating an opportunity for attackers to compromise the system 100. Correlating two or more cyber-security events allows organizations to uncover and address interdependent vulnerabilities that might otherwise remain undetected.

In another embodiment, event correlation or correlating two or more cyber-security events comprises agent-based approach. The agent-based approach enhances the event correlation by embedding autonomous agents directly on assets to collect telemetry data. These agents function as intelligent entities tasked with simulating an attacker's perspective.

Further, in an example, the agent is analogous to a task-oriented Large Language Model (LLM) programmed to perform adversarial analysis. Its primary goal is to “hack” the system by uncovering all potential exploit paths, dynamically identifying how two or more cyber-security events are interrelated and could collectively lead to a breach. The agent operates in real time, autonomously analyzing telemetry data to detect, correlate, and contextualize two or more cyber-security events directly from an asset environment. The agent then maps exploit paths by linking vulnerabilities, misconfigurations, and behavioral patterns, providing actionable insights into how these interconnected two or more cyber-security events could result in compromise. For instance, the agent might identify a leaked credential from stealer logs, trace its usage to misconfigured cloud servers or weak API keys, correlate these findings with active vulnerabilities (e.g., CVEs) and network exposures, and formulate a detailed exploit path that shows the potential steps an attacker could take to compromise the system 100.

Furthermore, once the two or more cyber-security events are correlated, the system 100 and method 300 employs a prioritization algorithm to rank threats based on factors like exploitability (the ease with which an attacker can leverage the vulnerability), asset criticality (the importance of the affected asset to the organization), business impact (the potential financial and operational consequences), likelihood of attack (the probability of an attacker exploiting the correlated vulnerabilities). This ensures that security teams focus on mitigating highest-priority risks, particularly those that span multiple related incidents across various systems.

The agent's adversarial simulation uncovers exploit paths that conventional systems might miss, ensuring a more comprehensive threat landscape analysis thereby providing enhanced threat detection.

Further, by simulating attacker behavior and correlating two or more cyber-security events in real time, the system 100 enables organizations to preemptively address vulnerabilities before they are exploited hence, providing a proactive defense.

Correlating telemetry data directly from assets enables the system 100 to deliver deeper contextual insights, empowering security teams to comprehend the “who, what, and how” of the one or more cyber-security threats. This enhanced correlation significantly improves the contextual understanding of threats, facilitating more informed decision-making and stronger defences against potential vulnerabilities.

In the agent-based approach the system 100 functions autonomously in diverse environments, seamlessly adapting to complex infrastructures without the need for manual intervention. Furthermore, the prioritization framework ensures that limited resources are focused on the most critical threats, maximizing the efficiency of security operations.

In some embodiments, the priority is assigned according to a probability of cyber loss associated with each cyber-security event from the one or more cyber-security events and the risk factor associated with the cyber-security event. Further, the probability is determined according to one or more characteristics of the organization comprising revenue, industry, location, and employee headcount.

In some embodiments, the one or more cyber-event parameters comprises business parameters comprising one or more of: data breach, ransomware, or financial fraud. In addition, the one or more cyber-event parameters comprises social media and dark web discussions for a technology resulting in a cyber-security threat associated with the one or more cyber-security events. In addition, the one or more cyber-event parameters comprise compliance status comprising data representing a probability of compliance of applicable regulatory requirements. The one or more cyber-event parameters also comprises patterns of cyber-security threat events determined from global threat event data mapping with the one or more cyber-security events.

In some embodiments, analyzing the one or more cyber-event parameters and the one or more identifier tags comprises identifying one of an increment or decrement in the social media and dark web discussions for the technology resulting in the cyber-security threat event.

In some embodiments, the one or more dynamic rules comprise a boosting rule or a diminishing rule, applied in response to an update in the analysis of one or more cyber-event parameters and weightage assigned to each identifier tag. Further, the update comprises one of an increment or decrement in the social media and dark web discussions for the technology resulting in the cyber-security threat event.

In some embodiments, the boosting rule is applied to boost the priority of the cyber-security event for the increment in the social media and dark web discussions. The diminishing rule is applied for the decrement in the social media and dark web discussions.

In addition to social media and dark web discussions, the system 100 can dynamically adapt to evolving threats by integrating real-time data from diverse sources. In an example, the one or more cyber-event parameters can be influenced by one or more of threat intelligence feeds, vulnerability databases, industry-specific alerts, and/or dark web monitoring.

In an example, the method 300 may include a step of enabling prioritization of cyber-security events based on organizational behaviour and external threat signals.

In another example, the method 300 comprises collecting the one or more cyber-security events from the computing environment. The computing environment may comprise one or more of: enterprise infrastructure and global threat intelligence feeds. The method 300 further comprises evaluating the prioritization of the one or more cyber-security events by way of: feedback from a user or an incident resolution outcome. In addition, the method 300 comprises updating, based on the evaluated prioritization, weightage of the one or more identifier tags and the one or more dynamic rules. Furthermore, the method 300 comprises reprioritizing, based on the updated weightage of the one or more identifier tags and the one or more dynamic rules, the one or more cyber-security events.

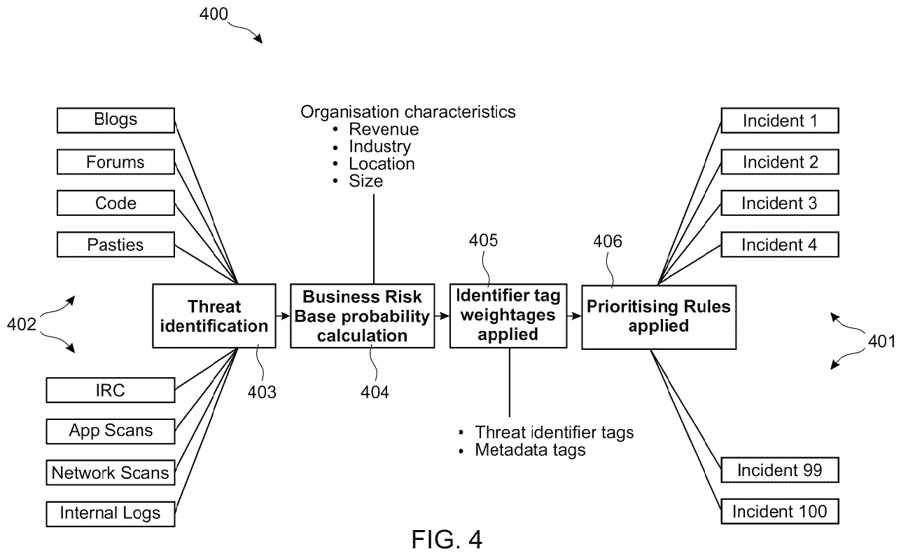

FIG. 4 illustrates additional details of the method 300 for estimating the risk in the computing environment of the organization due to the one or more cyber-security threat events, according to some embodiments of the invention. The additional details of the method 300 may comprises a scenario 400. The scenario 400 of the method 300 involve estimating a business and financial risk the organization faces from one or more cyber-security events 401. The scenario 400 includes collecting and monitoring 402 one or more data sources across the internet and provide predictions on the one or more cyber-security events 401. The scenario 400 further involves identifying 403 the one or more cyber-event parameters of an event that are critical to understand a business and financial risk of the cyber-security events 401 based on the data collected from the internet. Further, the scenario 400 includes calculating 404 a base probability based on one or more characteristic of the organization. The one or more characteristics of the organization include revenue, industry, location, and employee headcount. Based on the base probability, the system 100 predicts if the cyber-security events 401 can lead to business risk for the organization.

In addition, the scenario 400 includes extracting the one or more cyber-event parameters as identifier tags for one or more cyber-security events 401. Further, the scenario 400 includes assigning 405 a weightage for the contribution of each identifier tags to a specific business risk. The weightages are assigned after extensive research on past data and patterns on how cyber-security attacks have happened in the past. Once it is determined in that the one or more cyber-security events 401 is a business risk, the base probability is improved based on the identifier tags and the associated weightage it contributes to that specific business risk. In an example, the identifier tags may comprise threat identifier tags and metadata tags.

Further, the scenario 400 includes checking one or more dynamic rules which are specifically configured for the organization. The one or more dynamic rules are based on dynamic and daily observations of what is occurring in the cyber-security market and on the internet. Furthermore, the scenario 400 includes prioritizing 406 the one of more cyber-security events 401 (incident 1 to incident 100) based on the one or more dynamic rules. The one or more dynamic rules are configured to either boost or diminish the probability that a certain business risk will occur for that organization from the particular cyber-security event 401. In an example, the scenario 400 includes checking historical data of financial costs organizations have faced after the one or more cyber-security events 401. The scenario 400 further includes aggregating the data from multiple sources on the internet to build a database. The scenario 400 also includes estimating a financial dollar value loss for an organization from the one or more cyber-security events 401 based on the database created and the business risk calculated in the scenario 400.

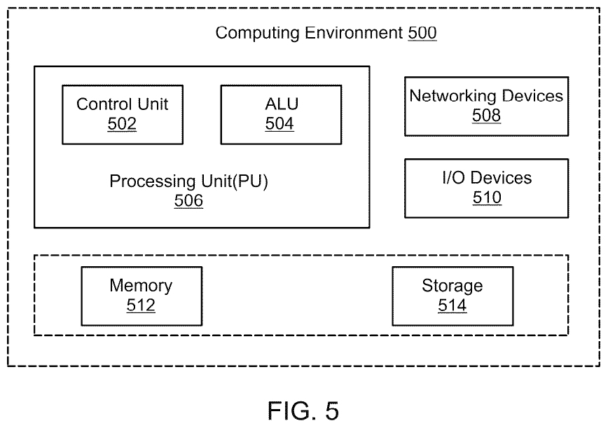

FIG. 5 illustrates an example computing environment 500 implementing the system 100, and method 300 as shown in FIGS. 1 and 3 for prioritizing one or more cyber-security events. As depicted in FIG. 5, the computing environment 500 comprises at least one data processing unit 506 that is equipped with a control unit 502 and an Arithmetic Logic Unit, ALU 504, a plurality of networking devices 508 and a plurality Input output, I/O devices 510, a memory 512, a storage 514. The data processing module 506 may be responsible for implementing the system 100, and the method 300 as shown in FIGS. 2 and 3 respectively. For example, the data processing unit 506 in some embodiments is equivalent to the controlling circuitry of the platform described above in conjunction with FIGS. 2 and 3. The data processing unit 506 is capable of executing software instructions stored in memory 512. The data processing unit 506 receives commands from the control unit 502 in order to perform its processing. Further, any logical and arithmetic operations involved in the execution of the instructions are computed with the help of the ALU 504.

The computer program is loadable into the data processing unit 506, which may, for example, be comprised in an electronic apparatus (such as the platform). When loaded into the data processing unit 506, the computer program may be stored in the memory 512 associated with or comprised in the data processing unit 506. According to some embodiments, the computer program may, when loaded into and run by the data processing module 506, cause execution of method steps according to, for example, any of the methods illustrated in FIG. 3, or otherwise described herein.

The overall computing environment 500 may be composed of multiple homogeneous and/or heterogeneous cores, multiple CPUs of different kinds, special media and other accelerators. Further, the plurality of data processing unit 506 may be located on a single chip or over multiple chips.

The algorithm comprises instructions and codes required for the implementation are stored in either the memory 512 or the storage 514 or both. At the time of execution, the instructions may be fetched from the corresponding memory 512 and/or storage 514 and executed by the data processing unit 506.

In case of any hardware implementations various networking devices 508 or external I/O devices 510 may be connected to the computing environment to support the implementation through the networking devices 508 and the I/O devices 510.

The embodiments disclosed herein can be implemented through at least one software program running on at least one hardware device and performing network management functions to control the elements. The elements shown in FIG. 5 include blocks which can be at least one of a hardware device, or a combination of hardware device and software module.

Although the present invention has been described in considerable detail with reference to certain preferred embodiments and examples thereof, other embodiments and equivalents are possible. Even though numerous characteristics and advantages of the present invention have been set forth in the foregoing description, together with functional and procedural details, the disclosure is illustrative only, and changes may be made in detail, especially in terms of the procedural steps within the principles of the invention to the full extent indicated by the broad general meaning of the terms. Thus, various modifications are possible of the presently disclosed system and process without deviating from the intended scope of the present invention.

What is claimed is:

1. A method for prioritizing one or more cyber-security events, the method comprising:
identifying one or more cyber-event parameters as identifier tags for one or more cyber-security events in a computing environment of an organization, wherein the one or more identifier tags facilitate in identifying a risk factor associated with each cyber-security event of the one or more cyber-security events;
creating one or more dynamic rules in response to analysis of the one or more cyber-event parameters and the one or more identifier tags of each cyber-security event;
applying, in real-time, the one or more dynamic rules to the one or more cyber-security events to assign a priority to each cyber-security event of the one or more cyber-security events; and
prioritizing the one or more cyber-security events as per the assigned priority of each cyber-security event.

2. The method according to claim 1, wherein the one or more cyber-event parameters comprise one or more attributes of the one or more cyber-security events collected from different sources, wherein the one or more attributes comprise at least one of a type of the corresponding cyber-security event, a source of the corresponding cyber-security event, a Targeted Asset, a severity score and a time of occurrence of the corresponding cyber-security event, and
wherein the one or more identifier tags comprise at least one of a threat indicator tag, an asset tag, a Common Vulnerabilities and Exposures (CVE) tag, a module tag, and a threat actor tag, wherein each identifier tag is assigned with a weightage that corresponds to contribution of the corresponding identifier tag in identifying the risk factor.

3. The method according to claim 2, wherein the risk factor facilitates to determine a business impact and a financial impact associated with the business impact, and an asset criticality.

4. The method according to claim 1, wherein the one or more dynamic rules arranges the one or more cyber-security events according to one or more threat levels associated with each cyber-security event.

5. The method according to claim 4, comprising:
applying one or more dynamic correlation rules to correlate one or more cyber-security events based on shared parameters, wherein the shared parameters comprise common assets associated with the two or more cyber-security events, vulnerability exposure of two or more cyber-security events, exploit paths, misconfigurations, or attacker behaviour patterns; and
assigning the priority to rank the two or more correlated events based on risk factors comprising at least one of an exploitability, asset criticality, business impact, and likelihood of attack.

6. The method according to claim 5, wherein the priority is assigned according to a probability of cyber loss associated with each cyber-security event from the one or more cyber-security events and the risk factor associated with each cyber-security event; and
wherein the probability is determined according to one or more characteristics of the organization comprising revenue, industry, location, and employee headcount.

7. The method according to claim 2, wherein the one or more cyber-event parameters comprises:
business parameters comprising one or more of: data breach, ransomware, or financial fraud;
social media and dark web discussions for a technology resulting in a cyber-security threat associated with the one or more cyber-security events;
compliance status comprising data representing a probability of compliance of applicable regulatory requirements; and
patterns of cyber-security threat events determined from global threat event data mapping with the one or more cyber-security events.

8. The method according to claim 7, wherein analyzing the one or more cyber-event parameters and the one or more identifier tags comprises:
identifying one of an increment or decrement in the social media and dark web discussions for the technology resulting in the cyber-security threat event.

9. The method according to claim 8, wherein the one or more dynamic rules comprise boosting rules or diminishing rules, applied in response to an update in the analysis of one or more cyber-event parameters and weightage assigned to each identifier tag; and
wherein the update comprises one of an increment or decrement in the social media and dark web discussions for the technology resulting in the cyber-security threat event.

10. The method according to claim 9, wherein the boosting rule is applied to boost the priority order of the cyber-security event for the increment in the social media and dark web discussions; and
wherein the diminishing rule is applied for the decrement in the social media and dark web discussions.

11. The method according to claim 2, comprising:
collecting the one or more cyber-security events from the computing environment;
evaluating the prioritization of the one or more cyber-security events by way of: feedback from a user or an incident resolution outcomes;
updating, based on the evaluated prioritization, weightage of the one or more identifier tags and the one or more dynamic rules; and
reprioritizing, based on the updated weightage of the one or more identifier tags and the one or more dynamic rules, the one or more cyber-security events.

12. A system for prioritizing one or more cyber-security events, the system comprising:
a memory unit;
a processor, wherein the processor is configured to:
identify one or more cyber-event parameters as identifier tags for one or more cyber-security events in a computing environment of an organization, wherein the one or more identifier tags facilitate in identifying a risk factor associated with each cyber-security event of the one or more cyber-security events;
create one or more dynamic rules in response to analysis of the one or more cyber-event parameters and the one or more identifier tags of each cyber-security event;
apply, in real-time, the one or more dynamic rules to the one or more cyber-security events to assign a priority to each cyber-security event of the one or more cyber-security events; and
prioritize the one or more cyber-security events as per the assigned priority of each cyber-security event.

13. The system according to claim 12, wherein the one or more cyber-event parameters comprise one or more attributes of the one or more cyber-security events collected from different sources, wherein the one or more attributes comprise at least one of a type of the corresponding cyber-security event, a source of the corresponding cyber-security event, a Targeted Asset, a severity score and a time of occurrence of the corresponding cyber-security event;
wherein the one or more identifier tags comprise at least one of a threat indicator tag, an asset tag, a Common Vulnerabilities and Exposures (CVE) tag, a module tag, and a threat actor tag, wherein each identifier tag is assigned with a weightage that corresponds to contribution of the corresponding identifier tag in identifying the risk factor.

14. The system according to claim 13, wherein the risk factor facilitates to determine a business impact and a financial impact associated with the business impact, and an asset criticality.

15. The system according to claim 13, wherein the one or more dynamic rules arranges the one or more cyber-security events according to one or more threat levels associated with each cyber-security event.

16. The system according to claim 15, wherein the processor is configured to:
apply one or more dynamic correlation rules to correlate one or more cyber-security events based on shared parameters, wherein the shared parameters comprise common assets associated with the two or more cyber-security events, vulnerability exposure of two or more cyber-security events, exploit paths, misconfigurations, or attacker behaviour patterns; and
assign the priority to rank the two or more correlated events based on risk factors comprising at least one of an exploitability, asset criticality, business impact, and likelihood of attack.

17. The system according to claim 16, wherein the priority is assigned according to a probability of cyber loss associated with each cyber-security event from the one or more cyber-security events and the risk factor associated with each cyber-security event,
wherein the probability is determined according to one or more characteristics of the organization comprising revenue, industry, location, and employee headcount.

18. The system according to claim 13, wherein the one or more cyber-event parameters comprises:
business parameters comprising one or more of: data breach, ransomware, or financial fraud;
social media and dark web discussions for a technology resulting in a cyber-security threat associated with the one or more cyber-security events;
compliance status comprising data representing a probability of compliance of applicable regulatory requirements; and
patterns of cyber-security threat events determined from global threat event data mapping with the one or more cyber-security events.

19. The system according to claim 18, wherein to analyze the one or more cyber-event parameters and the one or more identifier tags, the processor (102) is configured to identify one of an increment or decrement in the social media and dark web discussions for the technology resulting in the cyber-security threat event.

20. The system according to claim 19, wherein the one or more dynamic rules comprise a boosting rule or a diminishing rule, applied in response to an update in the analysis of one or more cyber-event parameters and weightage assigned to each identifier tag,
wherein the update comprises one of an increment or decrement in the social media and dark web discussions for the technology resulting in the cyber-security threat event.

21. The system according to claim 20, wherein the boosting rule is applied to boost the priority of the cyber-security event for the increment in the social media and dark web discussions; and
wherein the diminishing rule is applied for the decrement in the social media and dark web discussions.

22. The system according to claim 16, wherein the processor is configured to:
simulate one or more potential attack paths by way of an agent-based modeling technique, wherein the agent-based modeling technique employs one or more agents in the computing environment to mimic the attacker behaviour patterns by identifying exploitable vulnerabilities, correlating one or more cyber-security events, and constructing potential attack chains; and
reprioritize the correlated cyber-security events based on simulated one or more potential attack paths.

23. A non-transitory computer readable storage medium storing instructions, which when executed, cause the processor to execute the method according to claim 1.
